(19) United States
(12) Patent Application Publication
(10) Pub. No.: US 2026/0352360 A1
(43) Pub. Date: Nov. 5, 2026

(54) TRANSPORT-AGNOSTIC ALERTING SYSTEM

(71) Applicant: SpectraRep, LLC, Chantilly, VA (US)

(72) Inventors: Rodney G. HERRMANN, Agra, OK (US); Thomas J. BUONO, Spotsylvania, VA (US); Thomas C. BUONO, Warrenton, VA (US)

(73) Assignee: SpectraRep, LLC, Chantilly, VA (US)

(21) Appl. No.: 19/664,246

(22) Filed: Apr. 30, 2026

Related U.S. Application Data
(60) Provisional application No. 63/797,485, filed on Apr. 30, 2025.

(51) Int. Cl. H04H 20/59; G10L 13/08; H04H 60/23

(52) U.S. Cl. CPC H04H 20/59; G10L 13/08; H04H 60/23

(57) ABSTRACT

A transport-agnostic alerting system and method provide resilient emergency notification delivery through redundant communication layers. The system includes a receiver configured to monitor a plurality of ingress transport paths, including over-the-air television datacasting, radio frequency (RF) broadcasts, and internet-protocol (IP) networks. The receiver autonomously evaluates signal integrity across the plurality of paths to dynamically select an optimal audio source. Processed alerts are disseminated to a local ecosystem of devices via a tiered proximity-based wireless protocol comprising awareness beacons for proximity detection, alert beacons configured to wake backgrounded mobile applications, and peer relay beacons for mesh-based alert propagation. The receiver may further include a physical interface for connecting external transducers to output AI-synthesized audio with dynamic urgency modulation. The system ensures location-aware alert continuity across mobile, desktop, and public address endpoints, even during wide-area network infrastructure failures.

### CROSS-REFERENCE TO RELATED APPLICATIONS

This application claims priority to U.S. Provisional Application No. 63/797,485, titled “TRANSPORT-AGNOSTIC ALERTING SYSTEM,” filed Apr. 30, 2025, which is hereby incorporated by reference in its entirety.

### BACKGROUND

Effective public alerting requires a resilient, fault-tolerant system with redundant communication pathways to ensure critical messages reach recipients even during infrastructure failures. Traditional emergency alert systems (EAS) and public warning frameworks, such as Wireless Emergency Alerts (WEA), rely heavily on centralized internet protocol (IP) based infrastructure, including cellular networks (LTE/5G) and broadband internet. While effective under normal operating conditions, these networks are highly susceptible to failure during “Black Sky” events, such as natural disasters, cyberattacks on grid infrastructure, or extreme network congestion during public emergencies.

When cellular towers are overwhelmed, subject to load balancing, or when fiber-optic backhauls are severed, the “last-mile” delivery of life-saving information to the public is compromised. Modern systems often lack support for resilient legacy communication platforms that operate independently of these fragile IP-based networks. Furthermore, while traditional radio frequency (RF) broadcasts—such as NOAA Weather Radio (NWR)—offer high-power resilience and reach 90-95% of the population, they often lack the rich media capabilities (video, maps, multilingual text) and the targeted device integration (mobile phones, digital signage) expected by modern users and emergency managers.

Specifically, television stations operate on licensed spectrum, are managed 24/7 by skilled engineers, and utilize backup generators and high-capacity infrastructure (fiber, satellite uplinks, microwave backbones) that allow them to maintain service during power outages. However, standard consumer mobile devices are not equipped to ingest these broadcast signals directly, particularly when internet or cellular reception is unavailable.

### SUMMARY

In accordance with one or more embodiments, a transport-agnostic alerting system is provided, comprising a receiver and a dynamic, multi-channel delivery framework. The system enables the automatic detection, reception, and dissemination of emergency, weather, or public safety alert messages issued by authorized third-party sources or generated via a proprietary interface.

The system utilizes a transport-agnostic networking architecture that supports seamless communication over a plurality of delivery paths, including but not limited to: over-the-air (OTA) television datacasting, radio frequency (RF) signals, internet, LTE, and satellite networks. In the event of network congestion or infrastructure failure, the system executes a path-selection module configured to autonomously evaluate signal integrity and reroute traffic through the most optimal available transport path, ensuring uninterrupted alert delivery even in degraded or disconnected network conditions.

In some embodiments, the receiver is equipped with a multi-source tuner (e.g., a Weather Band decoder) capable of monitoring broadcast signals, extracting broadcast audio, and converting said audio into structured text for redistribution. This allows legacy analog alerts to be modernized and propagated as digital data across a user's device ecosystem.

According to another embodiment, the system implements a local-first recovery strategy and a tiered Bluetooth Low Energy (BLE) beaconing protocol. This protocol comprises awareness beacons for silent proximity detection and device-to-receiver “check-in,” alert beacons for high-priority emergency signaling designed to wake a mobile application from a background or locked state to trigger a native critical notification, and peer relay beacons that facilitate a proximity-amplified mesh by enabling devices that have acquired an alert to re-advertise a compact beacon signal to nearby peer devices.

Once a receiver is registered (e.g., via a MAC address and geolocation binding), any alert received via the transport-agnostic architecture is automatically propagated to a diverse range of linked endpoints. These endpoints include, but are not limited to, mobile communication devices, desktop, and laptop computers (e.g., via browser-based notifications), public address systems, high-output sirens, digital signage, and Internet of Things (IoT) devices. The system may further include an AI-driven neural text-to-speech (TTS) engine configured to generate real-time audio with dynamic urgency modulation, and a mapping module for generating dynamic, geospatially accurate visual assets based on alert coordinates.

### BRIEF DESCRIPTION OF FIGURES

Advantages of embodiments of the present invention will be apparent from the following detailed description of the exemplary embodiments. The following detailed description should be considered in conjunction with the accompanying figures in which:

FIG. 1 is a functional block diagram illustrating a transport-agnostic alerting system and high-level data flow from authenticated sources to a multi-modal delivery mesh, according to an embodiment of the present disclosure.

FIG. 2 is a schematic diagram illustrating the system architecture and multi-path transport infrastructure, including the integration of over-the-air (OTA) television datacasting and radio frequency (RF) inputs, according to an embodiment of the present disclosure.

FIG. 3 is a block diagram illustrating a detailed distribution process from a receiver to a variety of network-connected endpoints and the generation of AI-driven auditory and visual assets, according to an embodiment of the present disclosure.

FIG. 4 is a logic diagram illustrating a tiered Bluetooth Low Energy (BLE) beaconing protocol for proximity-based alert dissemination, mesh-based relay, and notification deduplication, according to an embodiment of the present disclosure.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

Many of the embodiments described herein are described in terms of sequences of actions to be performed by, for example, an Artificial Intelligence (AI) module or modules. It will be understood by those skilled in the art that the sequence of actions described herein can be embodied entirely within any form of AI or ML architecture such that execution of the sequence of actions enables the processor to perform the functionality described herein. Thus, the various aspects of the present invention may be embodied in a number of different forms, all of which have been contemplated to be within the scope of the claimed subject matter. For example, machine learning architectures include but are not limited to Artificial Neural Networks (ANNs), Multi-Layer-Perceptions (MLPs), Support Vector Machines (SVMs), Recurrent Neural Networks (RNNs), Convolutional Neural Networks (CNNs), Large Language Models (LLMs), transformers, decision trees, random forests, gradient boosting, nearest neighbor models, clustering algorithms, expert systems, mixture of experts models, ensemble models, diffusion models, reinforcement learning, and autoencoder models, to name a few. However, many other forms of AI and ML architectures that enable the processor to perform the same functionality have been considered.

It may generally be contemplated for any AI or machine learning architecture to be retrained according to the data processed herein, for example automatically or continuously retrained on a predetermined schedule or based on one or more triggers, such as based on one or more detected changes in the data.

It may be contemplated for execution of the sequence of actions contemplated to be undertaken by the AI or ML architecture to be based on data retrieved from any sensor contemplated herein, and for execution of the sequence of actions to include actuation of any of the one or more transducers contemplated herein.

In one or more exemplary embodiments transport-agnostic alerting system may be provided.

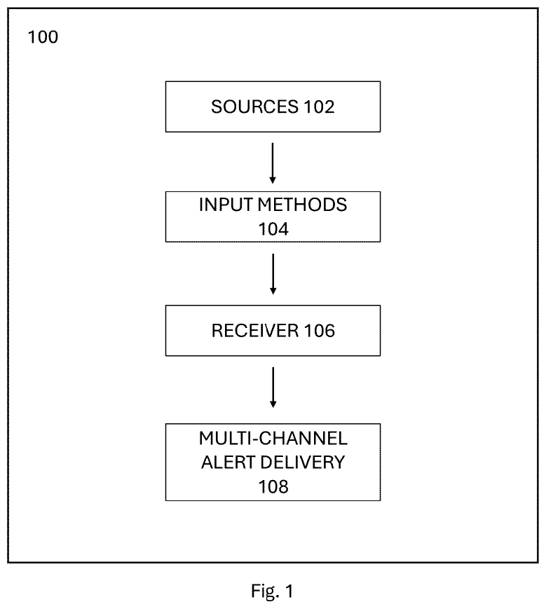

Referring to FIG. 1, a functional block diagram of a Transport-Agnostic Alerting System 100 is illustrated according to an exemplary embodiment. The system 100 comprises a resilient data pipeline designed to maintain the continuity of emergency notifications across disparate communication layers, particularly during infrastructure failures or network congestion.

The pipeline initiates at Sources 102, which represents authenticated originators of emergency, weather, or public safety information. These sources 102 may include, for example, governmental alerting authorities (e.g., FEMA IPAWS, NOAA, ShakeAlert), local emergency management offices, campus security operations centers (SOCs), regional emergency management agencies, or a proprietary administrative dashboard. The data generated by the sources 102 is typically structured according to a standardized messaging format, such as the Common Alerting Protocol (CAP), which may include geo-spatial coordinates, hazard levels, and multilingual text.

The alert data is propagated from the sources 102 to a plurality of Input Methods 104. These methods 104 function as a hybrid transport infrastructure comprising both internet-protocol (IP) based paths and non-IP broadcast layers. Specifically, the IP-based paths may include cellular networks (e.g., LTE, 5G), broadband internet, and satellite communication links. Conversely, the non-IP broadcast layers include over-the-air (OTA) television datacasting—where data is embedded within a digital television broadcast signal—as well as radio frequency (RF) terrestrial broadcasts (e.g., the 162 MHz Weather Band) that operate independently of traditional cellular and broadband network stacks.

A Receiver 106 is configured to interface with the input methods 104. The receiver 106 acts as an intelligent edge processor and comprises a hardware processor and a Path-Selection Module executed by the processor. The Path-Selection Module is configured to autonomously monitor available transport signals and evaluate a real-time signal integrity metric and a signal health parameter for each ingress path. In some embodiments, the Path-Selection Module compares the signal health parameter against a predefined threshold to determine when to transition between paths. Upon detecting a failure condition—such as when the signal health parameter falls below the threshold—the Path-Selection Module performs dynamic fallback routing, prioritizing resilient, one-way broadcast inputs (e.g., datacasting or RF). In some embodiments, the Path-Selection Module is further configured to ingest specialized Local Alerts, which may be injected into the transport stream to provide site-specific instructions that override or supplement broader regional notifications. The receiver 106 may further comprise processing modules for extracting analog audio from RF signals and converting said audio into structured digital text. Finally, the receiver 106 includes an alert distribution engine configured to disseminate the processed alert information to a Multi-Channel Alert Delivery framework.

The Multi-Channel Alert Delivery 108 framework supports a heterogeneous local device mesh that includes a wide array of personal and public infrastructure. This mesh comprises personal computing devices such as smartphones, tablets, and wearable devices, as well as desktop and laptop computers configured to receive alerts via browser-based push notifications, native application alerts, or specialized operating system interrupts. Beyond personal devices, the framework further interfaces with audible public safety hardware such as public address (PA) systems, high-output sirens, and external audio transducers connected via the receiver's physical interface. The delivery ecosystem is further extended to visual information displays, including digital signage, electronic billboards, and social media platform APIs, as well as networked Internet of Things (IoT) infrastructure such as smart home controllers, automated lighting systems, and secondary relay nodes. By encompassing this diversity of endpoints, the system ensures “last-mile” alert delivery across both private and public environments.

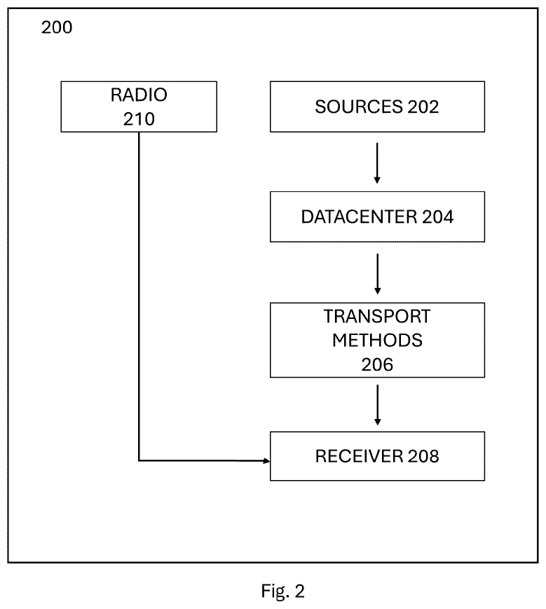

FIG. 2 is a schematic diagram illustrating a system architecture and multi-path transport infrastructure 200, according to an embodiment of the present disclosure. The architecture 200 facilitates the ingestion of data from a plurality of distinct communication layers to ensure alert redundancy and infrastructure resilience.

As illustrated, a plurality of Sources 202 (e.g., FEMA IPAWS, NOAA, local emergency management, campus security, or proprietary administrative dashboards) provides raw alert data to a Datacenter 204, which is configured as a Private Cloud environment (e.g., MidCon). The Datacenter 204 serves as a central aggregation and processing hub where the alert data is validated and prepared for dissemination. According to at least one exemplary embodiment the Datacenter 204 may include a comprehensive infrastructure stack including, for example, servers, networking, storage, security, and power, and is housed within a ruggedized edge-processing node characterized by high-durability physical infrastructure, such as a FEMA Zone-4 rating, a Seismic 2 rating, and a 12-inch double steel reinforced concrete bunker.

The Datacenter 204 may further include capabilities for content integration and management, as well as remote monitoring and control of the broader alerting network. Core functional capabilities of the Datacenter 204 may include encryption, targeting, transcoding, and a plurality of microservices designed for scalable data handling and full redundancy. To ensure delivery across disparate communication layers, the Datacenter 204 may be configured for transmitter routing to any or all available transport pathways, allowing the system to generate and direct specialized payloads—such as CAP messages, Local Alerts, audio/video files, or geotargeted metadata—to the most viable egress points.

The processed data is disseminated via one or more Transport Methods 206. In accordance with the transport-agnostic nature of the disclosure, these methods 206 comprise a hybrid of Internet Protocol (IP) and non-IP pathways. In some embodiments, the Transport Methods 206 include over-the-air (OTA) television datacasting via a secure datacasting network, wherein the alert data is transmitted as a one-way stream of encrypted IP data embedded within a digital television broadcast signal. This broadcast path leverages ruggedized infrastructure to maintain service during wide-area power outages or cellular network congestion. Other transport methods may include satellite communication, microwave backbones, or standard cellular and broadband networks.

A Receiver 208 is positioned to ingest the transmitted data from the Transport Methods 206. Simultaneously, the Receiver 208 is configured to monitor a secondary, legacy-resilient pathway via a Radio 210 input. The Radio 210 input allows the Receiver 208 to monitor radio frequency (RF) broadcasts, such as the 7 VHF-FM channels within the frequency range of 162.400 through 162.550 MHz (collectively known as the “Weather Band”). The Receiver 208 may maintain an independent ingestion path for NOAA Weather Radio All Hazards signals to ensure continuity even if the primary Datacenter 204 is unavailable.

In an exemplary embodiment, the Receiver 208 operates as a modernized, multi-source tuner. When the Receiver 208 is communicatively coupled to a user device (not shown), the system allows access to audio through up to three independent and redundant transport paths: over-the-air television datacasting, VHF radio broadcasts, and internet-based IP streams. The system is configured to monitor the availability of the plurality of transport paths and automatically transition to an active path when a primary connection is lost or interrupted, ensuring alert continuity across the local device mesh.

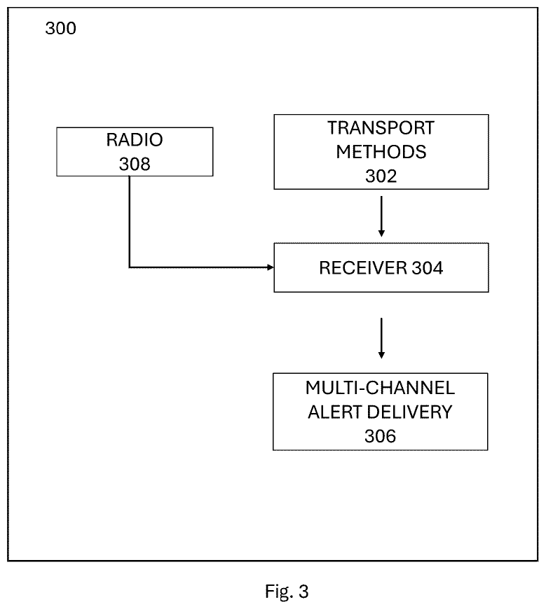

FIG. 3 is a block diagram illustrating a detailed distribution process 300 from a local processing hub to a variety of connected endpoints, according to an embodiment of the present disclosure. This process 300 focuses on the transformation of raw alert data into high-clarity, multi-modal notifications.

As illustrated, a Receiver 304 ingests data from a plurality of sources, including Transport Methods 302 and a Radio 308 input. The Receiver 304 acts as an edge processing node that integrates these inputs to maintain a unified alert state. In some embodiments, the Receiver 304 is registered by an end user (e.g., via a MAC address and geolocation binding) to ensure that the dissemination of information is location-aware. Once registered, any alert received by the Receiver 304 is automatically propagated to all devices linked to the receiver's MAC address regardless of the user's current location.

In some embodiments, the Receiver 304 comprises a physical USB hub or interface located on the receiver housing for the connection of auxiliary hardware. An external speaker or public address system may be connected to the physical USB hub, and the Receiver 304 outputs audio signals to the connected external speaker via the USB hub. The Receiver 304 or a connected microservice utilizes an AI-driven neural text-to-speech (TTS) engine to generate natural, human-like voice output from the alert text. This AI-driven synthesis may perform dynamic urgency modulation, wherein the system modulates tone, pitch, and cadence based on the hazard level or severity of the alert, or the local time. For instance, if a high-severity alert is received during nighttime hours, the AI-generated audio may adopt a sharper, more urgent delivery and automatically repeat through the connected USB speaker to maximize the chance of waking occupants and prompting immediate safety actions.

Furthermore, the Multi-Channel Alert Delivery 306 may include the generation and display of dynamic, geospatially accurate visual assets and the processing of rich media. The system supports specialized weather mapping services, including radar visualizations. For local visualization, a circular clarity region having a radius of approximately 50 miles is rendered around the device location. The map interface supports overlay layers, including lightning activity and wildfire or smoke information derived from data sources such as CAL FIRE, NASA FIRMS, and NOAA HMS smoke products. The system supports the delivery of streaming video or specific video files (e.g., emergency directions from a first responder) embedded and encrypted within a datacasting signal. This ensures that users receive comprehensive visual instructions and rich media content even when wide-area internet or cellular reception is unavailable. These assets can be displayed across mobile devices, desktops via browser-based notifications, or connected digital signage platforms.

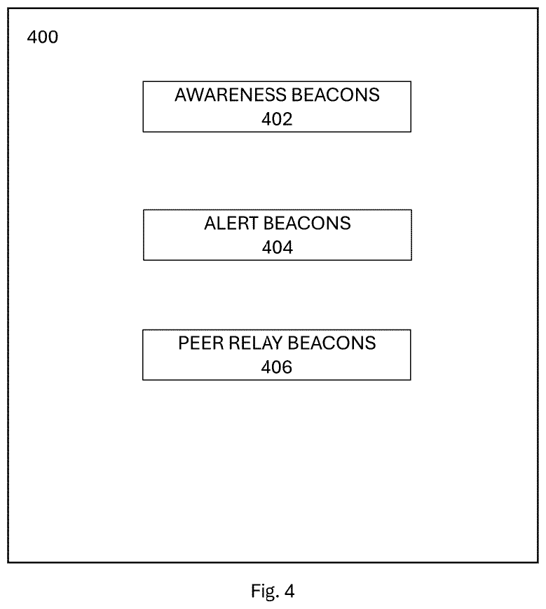

FIG. 4 is a logic diagram illustrating a tiered Bluetooth Low Energy (BLE) beaconing protocol 400 for proximity-based alert dissemination and application activation, according to an embodiment of the present disclosure. The protocol 400 is managed by a receiver (e.g., Receiver 304) to ensure “last-mile” delivery to end-user devices in a local ecosystem, enabling the delivery of alerts via alternative transport paths even during wide-area network outages or internet/LTE failures.

As illustrated, the protocol 400 comprises a plurality of distinct beacon types, including Awareness Beacons 402, Alert Beacons 404, and Peer Relay Beacons 406. These beacons operate at the physical layer to facilitate different stages of device interaction and alert propagation without requiring a persistent internet connection. The protocol is specifically configured to interact with a native mobile application downloaded from a standard application repository (e.g., App Store or Google Play Store) and is configured to deliver emergency alerts and critical information.

Awareness Beacons 402 are configured for silent proximity detection and device-to-receiver “check-in.” These beacons 402 are broadcast periodically as low-priority proximity signals to allow nearby mobile devices (e.g., smartphones with a native application) to establish a presence within the receiver's local range. This handshake ensures that the system maintains an accurate count of active endpoints ready to receive emergency data and optimizes power consumption by only activating high-power modules when endpoints are detected.

Alert Beacons 404 are high-priority emergency signals broadcast specifically when an active emergency, weather, or public safety alert is received by the system. Unlike standard background signals, Alert Beacons 404 are configured with specialized advertising packets designed to issue a native wake-up command that wakes a mobile application from a background, foregrounded, or locked state. In some embodiments, the specialized advertising packet comprises a specific Universally Unique Identifier (UUID) recognized by a mobile operating system as a critical alert trigger. Upon detection of an Alert Beacon 404, the native wake-up command bypasses the locked state of the mobile operating system to trigger a native, high-priority system critical notification, regardless of the device's wide-area network connectivity status. In the event of a Severe Weather Alert, the notification may bypass standard user-set quiet hours to ensure that critical safety information reaches the user immediately. The notification may include high-urgency audio synthesized in multiple languages such as English and Spanish and routes the user directly into the alert interface.

Peer Relay Beacons 406 facilitates a proximity-amplified mesh network. In some embodiments, once a first peer device has successfully acquired an alert (e.g., via a direct link to the receiver), that first peer device may be configured to briefly re-advertise a compact version of the alert signal as a Peer Relay Beacon 406. This allows the alert to “hop” to a second peer device that may be out of the direct broadcast range of the primary receiver, thereby extending the coverage area of the local alert mesh. The system includes built-in deduplication logic configured to suppress redundant notifications on the second peer device if an alert has been previously received via a primary ingress path (e.g., a direct IP-based link or a prior broadcast ingress). This ensures that a device that has already received and acknowledged an alert is not notified a second time through the relay path.

While the protocol 400 is described with respect to mobile devices, the tiered beaconing and deduplication logic are similarly applicable to the broader device mesh. For instance, desktop computers, digital signage, and IoT controllers within the local ecosystem may similarly monitor for Alert Beacons 404 via secondary wireless interfaces to trigger browser-based interrupts or infrastructure-level sirens, ensuring that the proximity-based dissemination reaches both personal and public safety hardware simultaneously.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A transport-agnostic alerting system for resilient emergency notification, comprising:
a receiver comprising a multi-source tuner, a hardware processor, and a physical interface port configured for connection to an external device;
the receiver configured to monitor a plurality of asynchronous ingress transport paths, the plurality of asynchronous ingress transport paths comprising an over-the-air television datacasting path, a radio frequency (RF) terrestrial broadcast path, and an internet-protocol (IP) data path, wherein the receiver is configured to ingest encrypted video files embedded within the over-the-air television datacasting path for simultaneous distribution to the local device mesh;
a path-selection module executed by the processor to:
evaluate a real-time signal integrity metric for each of the plurality of ingress transport paths; and
dynamically select an optimal audio source from one of the television datacasting paths or the RF terrestrial broadcast path upon detecting a failure condition in the IP data path;
an alert distribution engine configured to generate a tiered wireless beaconing protocol for a local device mesh, the protocol comprising:
an awareness beacon for proximity-based device discovery; and
an alert beacon comprising a specialized advertising packet configured to trigger a native wake-up command in a backgrounded mobile application;
wherein the receiver outputs an AI-synthesized audio signal to an external audio transducer via the physical interface port, the audio signal comprising a dynamic urgency modulation adjusted based on the severity of the alert and local time.

2. The system of claim 1, wherein the multi-source tuner is configured to monitor a plurality of VHF-FM channels within a frequency range of 162.400 MHz through 162.550 MHz.

3. The system of claim 1, wherein the receiver is further configured to initiate a registration sequence via a native mobile application, the registration sequence establishing a binding between a MAC address of the receiver and a geographic location context.

4. The system of claim 1, wherein the alert distribution engine is further configured to generate a dynamic map for display on a peer device, the dynamic map visualizing a geographic polygon defined by coordinates extracted from a Common Alerting Protocol (CAP) message.

5. (canceled)

6. The system of claim 1, wherein the specialized advertising packet of the alert beacon comprises a specific Universally Unique Identifier (UUID) recognized by a mobile operating system as a critical alert trigger.

7-9. (canceled)

10. A method for multi-path emergency alert dissemination across a resilient mesh network, comprising:
monitoring, at an edge receiver, a plurality of redundant ingress communication layers
comprising at least one non-IP broadcast layer and at least one IP-based transport layer;
evaluating, via a hardware processor, a signal health parameter for each of the plurality of redundant ingress communication layers;
automatically transitioning primary data ingress from the IP-based transport layer to the non-IP broadcast layer in response to the signal health parameter falling below a predefined threshold;
extracting an emergency data payload from the non-IP broadcast layer, the payload comprising Common Alerting Protocol (CAP) metadata;
broadcasting a high-priority wireless alert beacon from the edge receiver to a plurality of peer devices, the alert beacon configured to issue a native wake-up command that bypasses a locked state of a mobile operating system on the peer devices to trigger a system critical notification; and
re-advertising, via at least one of the peer devices, a compact version of the high-priority wireless alert beacon to extend a coverage range of the resilient mesh network, wherein the re-advertising includes a deduplication check to prevent redundant notifications on previously alerted peer devices.

11. The method of claim 10, further comprising synchronizing the emergency data payload across a plurality of endpoints including mobile devices, desktop computers via browser-based notifications, and digital signage.

12. The method of claim 10, wherein the high-priority wireless alert beacon comprises a Bluetooth Low Energy (BLE) advertising packet.

13. The method of claim 10, further comprising streaming a video file to the peer devices via the non-IP broadcast layer, the video file being encrypted and embedded within a digital television broadcast stream.

14. The method of claim 10, further comprising synthesizing an audio alert from the emergency data payload using a neural text-to-speech engine and outputting the audio alert to a speaker.

15. A transport-agnostic alerting system for resilient emergency notification, comprising:
a receiver comprising a multi-source tuner, a hardware processor, and a physical interface port configured for connection to an external device;
the receiver configured to monitor a plurality of asynchronous ingress transport paths, the plurality of asynchronous ingress transport paths comprising an over-the-air television datacasting path, a radio frequency (RF) terrestrial broadcast path, and an internet-protocol (IP) data path;
a path-selection module executed by the processor to:
evaluate a real-time signal integrity metric for each of the plurality of ingress transport paths; and
dynamically select an optimal audio source from one of the television datacasting paths or the RF terrestrial broadcast path upon detecting a failure condition in the IP data path;
an alert distribution engine configured to generate a tiered wireless beaconing protocol for a local device mesh, the protocol comprising:
an awareness beacon for proximity-based device discovery; and
an alert beacon comprising a specialized advertising packet configured to trigger a native wake-up command in a backgrounded mobile application;
wherein the receiver outputs an AI-synthesized audio signal to an external audio transducer via the physical interface port, the audio signal comprising a dynamic urgency modulation adjusted based on the severity of the alert and local time;
wherein the AI-synthesized audio signal is generated via a neural text-to-speech (TTS) engine that increases a repetition frequency of the audio signal during nighttime hours.

16. A transport-agnostic alerting system for resilient emergency notification, comprising:
a receiver comprising a multi-source tuner, a hardware processor, and a physical interface port configured for connection to an external device;
the receiver configured to monitor a plurality of asynchronous ingress transport paths, the plurality of asynchronous ingress transport paths comprising an over-the-air television datacasting path, a radio frequency (RF) terrestrial broadcast path, and an internet-protocol (IP) data path;
a path-selection module executed by the processor to:
evaluate a real-time signal integrity metric for each of the plurality of ingress transport paths; and
dynamically select an optimal audio source from one of the television datacasting paths or the RF terrestrial broadcast path upon detecting a failure condition in the IP data path;
an alert distribution engine configured to generate a tiered wireless beaconing protocol for a local device mesh, the protocol comprising:
an awareness beacon for proximity-based device discovery; and
an alert beacon comprising a specialized advertising packet configured to trigger a native wake-up command in a backgrounded mobile application;
a peer relay beacon configured to re-advertise a compact version of the alert beacon from a first peer device to a second peer device;
wherein the alert distribution engine includes deduplication logic configured to suppress redundant notifications on the second peer device if an alert has been previously received via one of the plurality of asynchronous ingress transport paths;
wherein the receiver outputs an AI-synthesized audio signal to an external audio transducer via the physical interface port, the audio signal comprising a dynamic urgency modulation adjusted based on the severity of the alert and local time.
